(19) United States
(12) Patent Application Publication
(10) Pub. No.: US 2009/0172770 A1
(43) Pub. Date: Jul. 2, 2009

(54) METHOD AND APPARATUS FOR RENTING COMPUTER PERIPHERAL DEVICES IN-SITU

(76) Inventors: David A. Sandage, Forest Grove, OR (US); Edward R. Harrison, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/967,590

(22) Filed: Dec. 31, 2007

(51) Int. Cl. G06F 21/00

(52) U.S. Cl. 726/1

(57) ABSTRACT

Embodiments of a system for renting one or more peripheral devices to a proximally disposed mobile device are disclosed herein. In some embodiments, a peripheral manager is configured to facilitate access to the one or more peripheral devices by the mobile device. The peripheral manager may also facilitate identification and/or authentication of the mobile device and/or its user, determine an access privilege of the mobile device and/or its user, and accept payment in exchange for the access by the mobile device and/or its user. Other embodiments are described and claimed.

### TECHNICAL FIELD

Embodiments of the invention relate to the field of data processing, in particular, to methods and apparatuses for renting peripheral devices in-situ for use with a mobile device.

### BACKGROUND

Mobile devices are becoming omnipresent in today's world. These devices are getting smaller in size day by day. Although smaller mobile devices are more portable, the usability of the mobile device decreases with a decrease in its size. In order to make a mobile device more portable, large display and keyboard are often the first things to be removed, yet it is these sorts of human interface devices that enhance ease of use of the mobile device. As a result, usability is often sacrificed. Often times, external peripheral devices may be coupled to the mobile device to circumvent this problem. For example, a laptop may be hooked to an external display, a keyboard, and/or a mouse. It may not, however, always be possible to carry such external peripheral devices along with the mobile device.

### BRIEF DESCRIPTION OF THE DRAWINGS

Embodiments of the invention will be described by way of exemplary embodiments, but not limitations, illustrated in the accompanying drawings in which like references denote similar elements, and in which:

FIG. 1 is a exemplary block diagram illustrating a peripheral management system interacting with a mobile device in accordance with various embodiments of the invention;

FIG. 2 is another exemplary block diagram illustrating the peripheral management system interacting with the mobile device in accordance various embodiments of the invention; and

FIG. 3 is an exemplary flow diagram illustrating the operation of the system of FIG. 2 in accordance with various embodiments of the invention.

### DETAILED DESCRIPTION OF ILLUSTRATIVE EMBODIMENTS

Illustrative embodiments of the invention include, but are not limited to, methods and apparatuses for renting peripheral devices in-situ for use with a mobile device.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having,” and “including” are synonymous, unless the context dictates otherwise. The phrase “A and/or B” means “(A), (B), or (A and B)”. The phrase “A/B” means “(A), (B), or (A and B),” similar to the phrase “A and/or B”. The phrase “at least one of A, B and C” means “(A), (B), (C), (A and B), (A and C), (B and C) or (A, B and C)”. The phrase “(A) B” means “(B) or (A B)”, that is, A is optional.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the invention. This application is intended to cover any adaptations or variations of the embodiments discussed herein. Therefore, it is manifestly intended that the embodiments of the invention be limited only by the claims and the equivalents thereof.

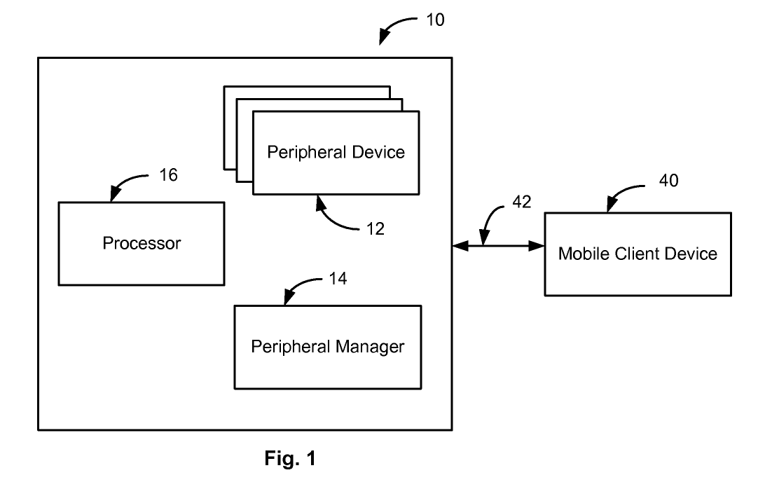

FIG. 1 is an exemplary block diagram illustrating a peripheral management system 10 interacting with a mobile device 40 in accordance with various embodiments of the invention. The peripheral management system 10 includes one or more peripheral devices 12. The peripheral devices 12 may be of any appropriate type, for example, display devices such as a monitor, user input devices such as a keyboard and a mouse, printing devices, etc. In some embodiments, the peripheral devices 12 include a monitor, a keyboard, a printer, and/or a mouse. The inventive principles of this disclosure are, however, not limited to any particular type of peripheral devices.

The peripheral management system 10 may also include a peripheral manager 14 and one or more processors 16. The peripheral manager 14 may be configured to be operated by the processor 16. Although illustrated as separate blocks, in some embodiments, the processor 16 may be integrated with the peripheral manager 14. In other embodiments, the peripheral manager 14 may be integrated with one of the peripheral devices 12.

FIG. 1 also includes a mobile device 40. The mobile device 40 may be of any appropriate type, e.g., a cellular phone, a laptop, a palmtop, a mobile gaming device etc. As understood by those skilled in the art, the inventive principles of this disclosure may also be applied to any other type of mobile devices. The mobile device 40 may access the peripheral management system 10 through a link 42. The link 42 may be a wired or a wireless link. In some embodiments, the link 42 is a wireless link employing an appropriate Institute of Electrical and Electronics Engineers (IEEE)802.11 protocol, e.g., IEEE 802.11b protocol released on 1999, IEEE 802.11g protocol released on 2003, or any other appropriate IEEE 802.11 protocol. In other embodiments, the link 42 is a wireless link employing the Bluetooth™ protocol. In yet other embodiments, the link 42 is a wired link employing the Universal Serial Bus (USB) protocol. Any other appropriate protocol, known to those skilled in the art, may also be used in other embodiments. In some embodiments, the mobile device 40 may be proximally placed to the peripheral management system 10, for example, in the same room, the same building, the same terminal in an airport, or within an appropriate distance such that the mobile device 40 may effectively communicate with the one or more peripheral devices 12 and/or the peripheral manager 40 either through an appropriate wired or a wireless connection.

The mobile device 40 may access one or more of the peripheral devices 12 through the link 42. The peripheral manager 14 may control the access. In some embodiments, the peripheral manager 14 may rent one or more of the peripheral devices 12 to its users for use with the mobile device 40. According to some embodiments, renting may include, but is not limited to, rights to access the one or more peripheral devices 12 for certain duration of time upon fulfilling certain criteria, including, for example, paying the peripheral management system 10 for accessing the one or more peripheral devices 12. According to some other embodiments, renting may include, but is not limited to, leasing the one or more peripheral devices to the mobile device 40 or its user for certain duration of time upon paying the peripheral management system, as would be explained in details later. According to some embodiments, a user may include, but is not limited to, a user of the mobile device 40. According to some embodiments, a mobile device/user includes the mobile device 40 and/or the user of the mobile device 40. According to some embodiments, the phrase “accessing peripheral devices 12” would mean accessing one or more of the peripheral devices 12.

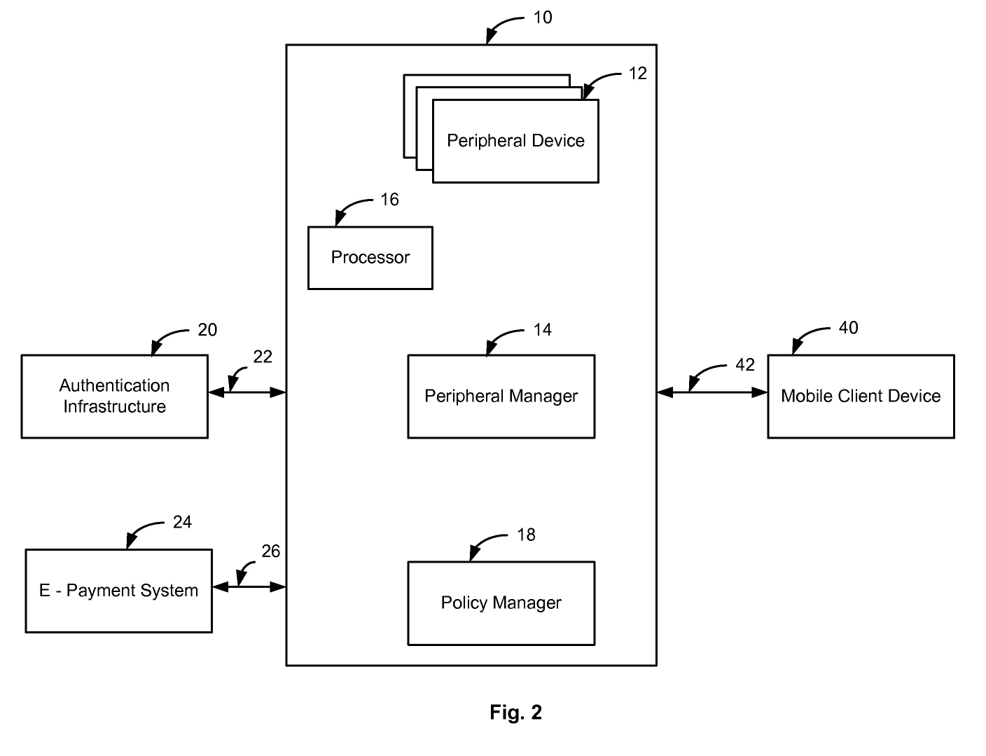

FIG. 2 is a more detailed block diagram illustrating the peripheral management system 10 interacting with the mobile device 40 in accordance with various embodiments of the invention. Similar to FIG. 1, the peripheral management system 10 of FIG. 2 includes one or more peripheral devices 12, peripheral manager 14, and one or more processors 16.

The peripheral management system 10 may also include a policy manager 18. The peripheral manager 14 may communicate with the policy manager 18 to receive usage/access policy associated with the mobile device 40/user, as would be explained in more details later. Although shown as separate blocks, the policy manager 18 may, in some embodiments, be integrated with or be a part of the peripheral manager 14. In other embodiments, the policy manager 18 may be separate from the peripheral management system 10 and may reside in a location remote to the peripheral management system 10. In that case, the peripheral management system 10 may communicate with the policy manager 18 through an appropriate wired or wireless link.

The peripheral management system 10 may also communicate with an authentication infrastructure 20 to authenticate the identity of the mobile device 40/user, as would be explained in details later. Although shown as a separate block, the authentication infrastructure 20 may, in some embodiments, be integrated with the peripheral management system 10.

The peripheral management system 10 may also communicate with an E-payment system 24 to accept payment from the mobile device 40/user, as would be explained in details later. Although shown as a separate block, the E-payment system 20 may, in some embodiments, be integrated with the peripheral management system 10.

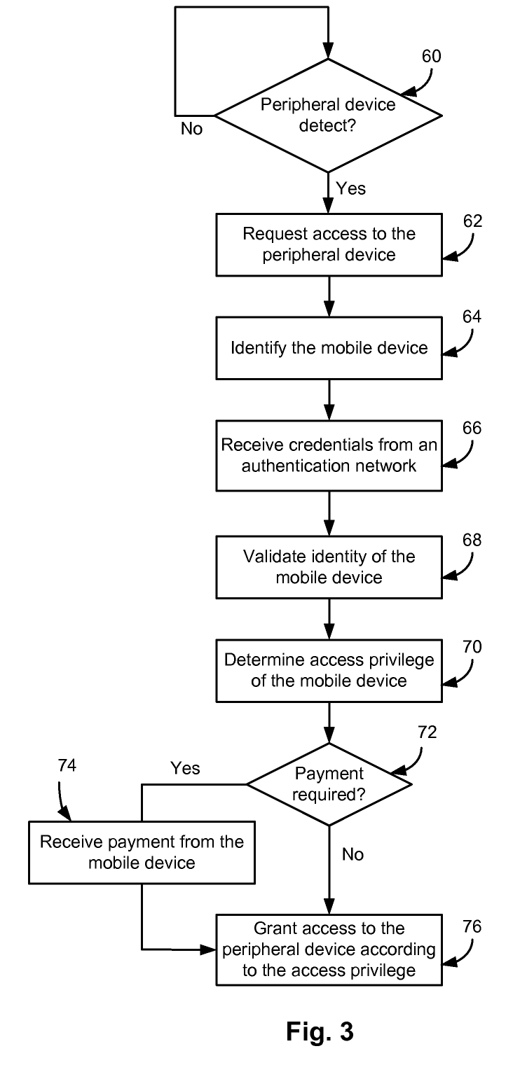

FIG. 3 is a flow diagram illustrating the operation of the system of FIG. 2. At 60, the mobile device 40/user detect the presence of the peripheral devices 12 available for rent. In some embodiments, the user of the mobile device 40 may visually detect the presence of the peripheral devices 12. Alternatively, the mobile device 40 may wirelessly detect the presence of the peripheral devices 12 in the vicinity by detecting a wireless signal emitted by the peripheral management system 10 indicating its availability for rent. Alternatively, the mobile device 40 may use an electronic directory of available peripherals to detect the presence of the peripheral devices 12.

Upon detection of the peripheral devices 12, the mobile device 40/user may request access to one or more of the peripheral devices 12 at 62. The request for accessing the peripheral devices 12 may include the duration of time the mobile device 40/user intends to access the peripheral devices 12. The mobile device 40 or its user may also transmit its identity to the peripheral management system at 64 along with the request for accessing the peripheral devices 12.

The mobile device 40/user may transmit the request and its identity through an appropriate interactive system included in the peripheral management system 10. In some embodiments, the user may swipe the mobile device 40 on a Radio Frequency Identification (RFID) reader built in the peripheral management system 10, which may transmit the request and the identity of the mobile device to the peripheral manager 14. Alternatively, the user may use an identification card, including, for example, a credit card, a peripheral device rental card, and/or an employment identification card, to request access to the peripheral devices 12 and to identify himself to the peripheral manager 14. It would be apparent to those skilled in the art that any other appropriate method may be adopted to request access to the peripheral devices and to identify the mobile device 40/user to the peripheral manager 14. For example, the user may select the peripheral devices he intends to rent using an interactive computer screen included in the peripheral management system 10 and log in the peripheral management system using a pre-assigned user id and password.

In some embodiments, the mobile device 40/user may transmit the request to access the peripheral devices 12 and identify itself by swiping the mobile device 40 on an RFID reader built in one of the peripheral devices 12. The peripheral devices 12 may, in turn, transmit this information to the peripheral manager 14.

After receiving the request for accessing the peripheral devices 12 at 62 and after identifying the mobile device 40/user at 64, the peripheral manager may transmit this information to the authentication infrastructure 20 to validate the identity of the mobile device 40/user. Any communication with the authentication infrastructure 20 may be encrypted using techniques commonly used in the art. At 66, the peripheral manager 14 may receive credentials of the mobile device 40/user from the authentication infrastructure 20. In some embodiments, the peripheral manager 14 may receive the public key of the mobile device 40/user from the authentication infrastructure 20, which may be subsequently used to validate the identity of the mobile device 40 at 68. The peripheral manager may also exchange a challenge/response sequence with the mobile device 40 to validate the identity of the mobile device 40/user. Appropriate encryption techniques using public and private keys and challenge/response sequence are well known in the art, and accordingly will not be further described.

After validating the identity of the mobile device 40/user, the peripheral manager 14 may transmit the identity to the policy manager 18. The policy manager 18 may determine the access privilege of the mobile device 40/user and transmit the access privilege information to the peripheral manager 14 at 70.

Access privilege of the mobile device 40/user may depend on several factors. For example, in some embodiments, a user may purchase a daily pass to access the peripheral devices 12; in that case, the peripheral manager 14 may grant the mobile device 40/user unlimited access to the peripheral devices 12 throughout the day. Similarly, a user may buy a weekly or a monthly pass and have unlimited access to the peripheral devices 12 for the duration of time specified in the pass. In other embodiments, the user may purchase an access pass to access the peripheral devices 12 for certain duration of time, and the peripheral manager 14 may allow the mobile device 40/user access to the peripheral devices 12 until the time in the access pass has exhausted. Any other appropriate access schemes may be devised according to the need. For example, if the peripheral management system 10 is installed in an airport and the user is an airport employee, the user may be given access to the peripheral devices 12 without any financial charge or at a reduced hourly rate. In some embodiments, different categories of users may be charged differently for accessing the peripheral devices 12. For example, a staff at the airport may be charged an hourly rate which is lower than that of an owner of a coffee shop at the airport, while a passenger at the airport may be charged differently. In some embodiments, if the user is the administrator of the peripheral system 10, the user may be granted full access to the system, including permission to configure the system.

After receiving the access privilege of the mobile device 40/user, at 72 the peripheral manager 14 determines whether the mobile device 40/user needs to make a payment to access the peripheral devices 12. This determination may be based on the access privileges of the mobile device 40/user and the duration of time the mobile device 40/user requested access to the peripheral devices 12. For example, if the user had earlier purchased a daily or a monthly pass or is otherwise privileged to access the peripheral devices 12, no further payment would be required from the user. In another exemplary situation, if the user had earlier purchased an access pass for 10 hours, have already exhausted 9 hours from it, and have currently requested access to the peripheral devices 12 for 3 hours, the user would be required to pay for 2 hours only. A new user may be given an option of purchasing different categories of access passes (e.g., hourly, daily, monthly etc.), or may be charged only for the duration of time for which the mobile device 40/user has requested access to the peripheral devices 12.

If a payment is required from the user to access the peripheral device, at 74 the peripheral manager 14 may receive payment from the mobile device 40/user using the E-payment system 24. Any appropriate electronic payment system may be utilized to receive payment from the user. Such electronic payment systems are well known in the art, and accordingly will not be further described.

After receiving any required payment, at 76 the peripheral manager 14 grants the mobile device 40/user access to one or more of the peripheral devices 12 according to the access privilege of the mobile device 40/user and for the duration of time for which payment has been received. In case a payment is not required from the mobile device 40/user at 72, the peripheral manager 14 may grant the mobile device 40/user access to one or more of the peripheral devices 12 at 76 based on the access privilege of the mobile device 40/user.

The peripheral manager then links the mobile device 40 and the one or more peripheral devices 12 in such a way that all policy restrictions and access privileges are followed. A policy restriction may, for example, restrict the maximum time a peripheral device may be rented during a rush hour, restrict the maximum number of pages that may be printed using a peripheral device (e.g., a printer), or any other appropriate policy imposed by the administrator of the peripheral system. Access privileges may, for example, restrict the duration of time the user may access the peripheral device, restrict access to certain services based on the category of the user (e.g., an employee, the administrator of the system, a general user etc.), as has been discussed before. Linking the mobile device 40 and the one or more peripheral devices 12 may be done using any appropriate techniques known to those skilled in the art.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the invention. This application is intended to cover any adaptations or variations of the embodiments discussed herein. Therefore, it is manifestly intended that the embodiments of the invention be limited only by the claims and the equivalents thereof.

1. An apparatus comprising:
one or more peripheral devices;
one or more processors; and
a peripheral manager configured to be operated by the one or more processors to control an external access of the one or more peripheral devices.

2. The apparatus of claim 1, wherein the peripheral manager is configured to authenticate an external mobile client device or a user of the external mobile client device desired to access the one or more peripheral devices.

3. The apparatus of claim 2, wherein the peripheral manager is configured to receive an identification of the external mobile client device or the user of the external mobile client device.

4. The apparatus of claim 2, wherein the peripheral manager is configured to receive credentials of the external mobile client device or the user from an authentication infrastructure external to the apparatus.

5. The apparatus of claim 1, wherein the peripheral manager is further configured to facilitate accepting a payment for the access of the one or more peripheral devices.

6. The apparatus of claim 1, further comprising a policy manager operated by the one or more processors to determine an access privilege of an access of the one or more peripheral devices.

7. The apparatus of claim 6, wherein the peripheral manager is further configured to determine the access privilege of an external mobile client device or a user of the external mobile client device.

8. The apparatus of claim 6, wherein the peripheral manager is further configured to determine an amount of payment to be received for accessing the one or more peripheral devices, based on the determined access privilege or on a duration of time of the access, or both.

9. The apparatus of claim 8, wherein the peripheral manager is further configured to control the access to the one or more peripheral devices in response to receiving the determined payment.

10. A mobile device comprising:
a peripheral interface; and
logic configured to send information to, or receive information from a peripheral manager external to the mobile device to enable the peripheral interface to gain access to a peripheral device external to the mobile device.

11. The mobile device of claim 10, wherein the logic is configured to authenticate the mobile device or a user of the mobile device to the peripheral manager.

12. The mobile device of claim 10, wherein the logic is configured to facilitate a payment for a right to access a discovered proximally disposed peripheral device by the mobile device.

13. The mobile device of claim 10, further comprising a radio frequency identification tag to identify the mobile device or the user to the peripheral manager.

14. The mobile device of claim 10, wherein the logic is further configured to authenticate the mobile device or a user of the mobile device to the peripheral manager, including responding to a challenge sequence from the peripheral manager.

15. The mobile device of claim 10, wherein the mobile device comprises a selected one of a mobile phone or a personal digital assistant.
